(19) United States
(12) Patent Application Publication
(10) Pub. No.: US 2004/0191369 A1
(43) Pub. Date: Sep. 30, 2004

(54) Method and device for preserving perishable products

(75) Inventor: Jacques Veillon, Saint-Denis Le-Ferment (FR)

Correspondence Address: IP DEPARTMENT OF PIPER RUDNICK LLP, ONE LIBERTY PLACE, SUITE 4900, 1650 MARKET ST, PHILADELPHIA, PA, 19103, US

(73) Assignee: IBI, a corporation of France, Hodent (FR)

(21) Appl. No.: 10/796,348

(22) Filed: Mar. 9, 2004

Related U.S. Application Data
(63) Continuation of application No. PCT/FR02/03133, filed on Sep. 13, 2002.

(30) Foreign Application Priority Data
Sep. 13, 2001 (FR) FR 01/11828
Mar. 1, 2002 (FR) FR 02/02650
Mar. 28, 2002 (FR) FR 02/03950

(51) Int. Cl. C12C 1/027

(52) U.S. Cl. 426/106

(57) ABSTRACT

A method of preserving a perishable product placed in a container including attaching a flexible envelope including at least one protruding tab on at least a part of ends of the container to form an airtight casing for the products evacuating fluid contained in the casing by spreading at least one of the tabs to form a temporary passage between the interior and exterior of the casing, compressing or pressing the flexible envelope against the products and/or the container such that the fluid trapped in the casing is removed via the temporary passage, blocking the passage, and inserting at least one of the tabs inside the casing to form a communication conduit between the interior and the exterior of the casing; and a preservation device including a multiplicity of protruding tabs, at least one of the protruding tabs having a greater length than the other tabs.

### RELATED APPLICATION

This is a continuation of International Application No. PCT/FR02/03133, with an international filing date of Sep. 13, 2002 (WO 03/022702, published Mar. 20, 2003), which is based on French Patent Application Nos. 01/11828, filed Sep. 13, 2001, 02/02650, filed Mar. 1, 2002, and 02/03950, filed Mar. 28, 2002.

### FIELD OF THE INVENTION

This invention pertains to a device for preserving perishable products. It is applicable especially, but not exclusively, to foods such as dishes constituted, for example, by fresh or processed vegetables, cooked meats and/or starchy foods.

### BACKGROUND

Presently known on the market are rolls of thin films, generally made of a transparent plastic and rolled around a cylinder which is conventionally made of cardboard. These films can be cut relatively easily to be placed on a dish in order to improve its preservation. Said film has intrinsic characteristics such that it clings or adheres to said dish. However, this system does not allow reuse of the thin film because of its fragility and clinging properties. The user therefore is forced to regularly purchase new rolls. These purchases of rolls represent a non-negligible expense.

Moreover, this system does not provide the possibility of efficiently preserving foodstuffs. The spoiling of foods is essentially due to their contact with atmospheric air which causes their spoilage. However, this thin-film system does not constitute or provide an easy and effective means for removing the atmospheric air trapped between the thin film and the foods to be preserved.

FR 2737467 pertains to a preserving and packaging method, especially for food products stored in a hermetically sealed, transportable container that can be kept at ambient temperature or at the desired temperature. The interior of the container is placed under a partial vacuum before it is sealed. The container is constituted of a flexible or semirigid plastic such that the volume of air remaining inside the airtight volume allows a slight deformation of the plastic container to equilibrate the internal and external pressures during the temperature increase of the heat treatment.

However, this method employs a very complex, expensive device that suctions out the air trapped inside the container to mechanically create a partial vacuum. Thus, this system requires the use of a specific instrument for creating the vacuum and an ordinary individual rarely possesses this type of instrument, which makes this method extremely expensive and thus limited to certain categories of professionals, e.g., restaurant professionals.

### SUMMARY OF THE INVENTION

This invention relates to a method of preserving a perishable product placed in a container including attaching a flexible envelope including at least one protruding tab on at least a part of ends of the container to form an airtight casing for the products, evacuating fluid contained in the casing by spreading at least one of the tabs to form a temporary passage between the interior and exterior of the casing, compressing or pressing the flexible envelope against the products and/or the container such that the fluid trapped in the casing is removed via the temporary passage, blocking the passage, and inserting at least one of the tabs inside the casing to form a communication conduit between the interior and the exterior of the casing.

This invention also relates to a preservation device including a multiplicity of protruding tabs, at least one of the protruding tabs having a greater length than the other tabs.

### BRIEF DESCRIPTION OF THE DRAWINGS

One aspect of the invention will be described below as a nonlimitative example with reference to the attached figures in which:

FIG. 1 is a perspective view of the device for preserving perishable products according to aspects of the invention;

FIG. 2 is a top view of the device show in FIG. 1;

FIG. 3 is a view in vertical section along the axis X′X of the device shown in FIG. 2;

FIGS. 4 to 8 illustrate sectional views of the different steps of attachment of the device for preserving perishable foods according to aspects of the invention placed in a cylindrical container, for example, a can for food;

FIGS. 9 to 10 show an example of the method according to aspects of the invention in which a second envelope is attached to the container and/or to the first envelope;

FIG. 11 is a perspective view of a region of the envelope according to aspects of the invention;

FIG. 12 is a view in vertical section of the region of the envelope shown in FIG. 11;

FIG. 13 is a view in vertical section of a mode of implementation of the device for preserving perishable products according to the invention; and

FIG. 14 is a view in vertical section of a region of the preservation device shown in FIG. 13.

### DETAILED DESCRIPTION

It will be appreciated that the following description is intended to refer to specific embodiments of the invention selected for illustration in the drawings and is not intended to define or limit the invention, other than in the appended claim.

This invention provides a method of preserving perishable products placed in a container comprising a step of attaching a flexible envelope comprising at least one protruding tab on at least a part of the ends of the container to form an airtight casing for the foodstuffs, characterized in that it comprises: a spreading step consisting of spreading at least one of the tabs to form a temporary passage between the interior and the exterior of the casing, a step of compression or pressing of the flexible envelope against the foodstuffs and/or the container such that the fluid, e.g., the atmospheric air, trapped in the casing is removed via the temporary passage, and a step of blocking the passage.

The term “preserving” is understood to mean protecting perishable products until their consumption and/or their use.

The method according to the invention advantageously comprises a prior step comprising stretching the flexible envelope such that it fits perfectly to the ends of the container.

According to one aspect of the invention, the method also comprises a step of insertion of at least one of the tabs inside the casing to form a passage between the interior and the exterior of said casing. Subsequent to this step of insertion of at least one tab in the casing, the method comprises a step of heating and/or cooking the foodstuffs enclosed in the casing by microwave means or other equivalent equipment. Because of these specific attributes, the invention makes it possible to significantly improve the preservation and taste especially of foods by providing a simple, effective system that has the advantage of being indefinitely reusable.

According to another aspect of the invention, the method of the invention could comprise a step of writing on one of the surfaces, ideally the external surface, of the envelope, e.g., to identify the foodstuffs present in the casing. Similarly, the method of the invention can comprise a step of attachment, e.g., by gluing, of a support illustrating, e.g., an advertisement, a warning related to the foodstuffs and/or a communication of a general nature, on one of the surfaces of the envelope according to the invention.

The invention also pertains to a preservation device for implementing the method comprising ensuring the preservation of perishable products placed in a container, comprising an elastically deformable envelope, characterized in that it comprises a multiplicity of protruding tabs. According to one aspect of the invention, the envelope has an essentially circular plane surface at the end of which extends perpendicularly a portion of essentially cylindrical form. In this example, the protruding tabs are located essentially at the ends of the cylindrical portion.

Similarly, the invention comprises four tabs having equivalent dimensions and they are positioned in pairs facing each other. The envelope also comprises at least one protruding tab, ideally having a length greater than that of the other tabs. The envelope is preferably made of plastic. Thus, the envelope can be made of a conventional elastomer, such as a silicone.

FIG. 4 shows that the preservation method according to the invention is applicable to conventional containers, here a porcelain plate 1. It is, however, clear that this invention is applicable to various types of containers, whether they be made of plastic, porcelain, glass, metal, wood or any other material.

FIG. 1 shows a flexible envelope 2 made of an elastomer, e.g., silicone, to confer elastic properties enabling it to fit on all forms of containers because it is elastically deformable.

Similarly, the envelope is created in an airtight manner such that its airtight character is maintained when it is stretched to adapt itself to containers of food products, non-food or industrial products and it is made such that it can fit the product 10 that it preserves. For this purpose, the envelope 2 can be made of a material capable of resisting variable temperatures ranging from freezing to heating by microwaves or equivalent method.

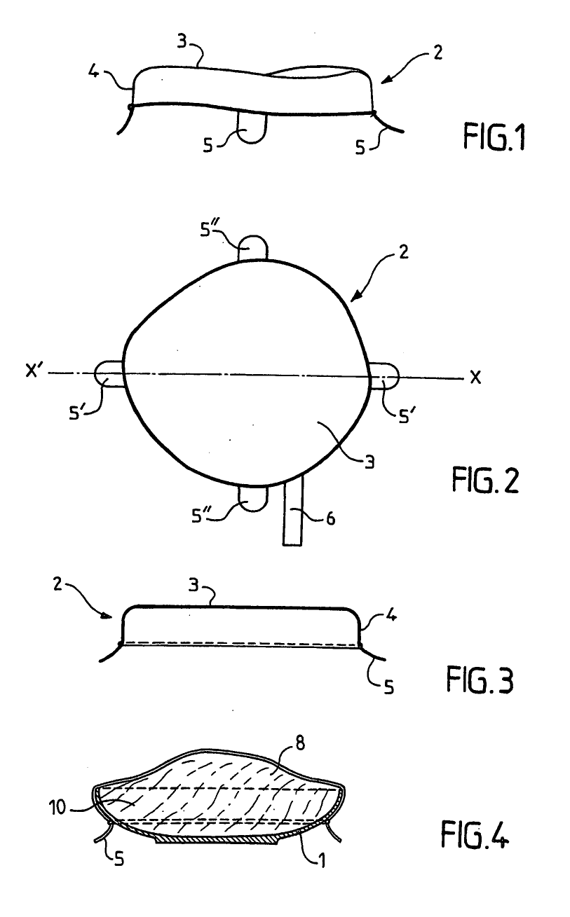

The envelope 2 has an essentially spherical plane surface 3 at the end of which extends perpendicularly a cylindrical portion 4. As can be seen in FIG. 2, the envelope 2 also comprises four protruding tabs 5 arranged in pairs opposite each other, i.e., two tabs 5′ on the axis X′X and two tabs 5″ arranged on a diametric line perpendicular to axis X′X. The four tabs 5′ and 5″ extend in the same plane parallel to the plane of the plane surface 3 of the envelope 2.

The envelope moreover comprises an elongated tab 6 of size and shape different from that of the four other tabs 5′ and 5″, but extending in the same plane as the tabs 5′ and 5″.

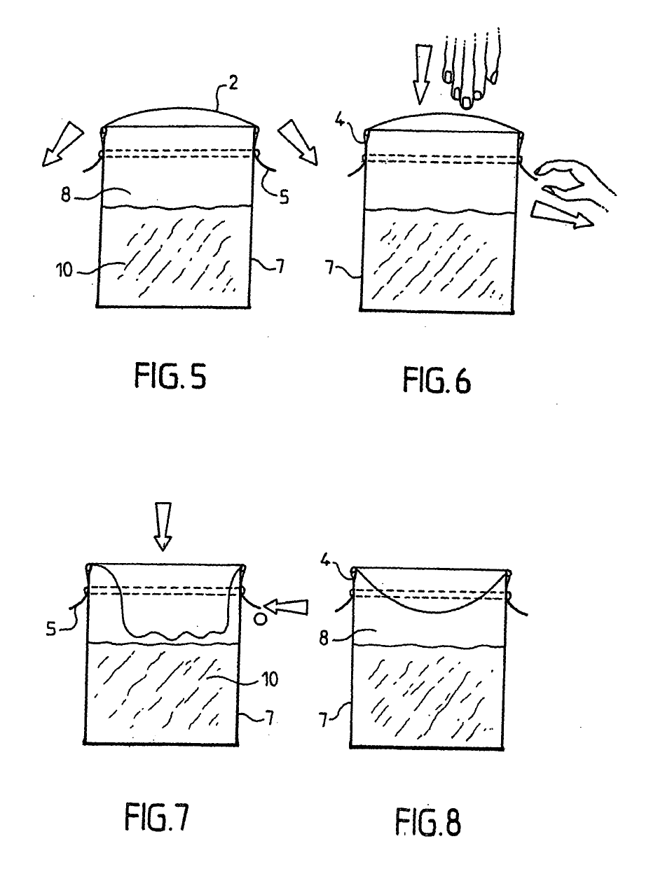

The flexible envelope 2 is placed on a container, or more precisely on the opening of a container 1 or of a container such as a can for food 7 as shown in FIGS. 5 to 8, elastically stretching the envelope 2 so that it best fits over the contours or ends of the container. The cylindrical potion 4 in particular allows the envelope 2 to fit well and in a manner impervious to fluids, such as the atmospheric air, to the different forms of the ends of a container 1 or the openings of a container. Thus, when the envelope 2 is fitted on the ends of a container 1 or on the opening(s) of a container, the container forms with the envelope a tight, enclosed casing 8.

The user of envelope 2, once the envelope has been attached to a container 1 in which have been placed products, e.g., perishable food products, can easily expel atmospheric air by pulling on one of the tabs 5, 5′ or 5″ to form a conduit or passage allowing communication between the interior of the casing 8 and the ambient air.

Subsequently or simultaneously, the user uses the other hand to press or compress the plane surface 3 of the envelope 2 against the foodstuffs and/or the surface of the container 1 so that the air trapped in the casing 8 is removed via the conduit or passage formed for this purpose.

After the air or gas initially present in the casing 8 has been removed from the casing 8, the user reattaches the envelope 2 in an airtight manner on the ends or opening of the container in a manner to block or close the temporary conduit or passage intended for removing the air initially present in the casing 8.

The device according to the invention also makes it possible to heat and/or cook the product located in the casing 8 between the envelope 2 and the container 1 because these two latter elements 1 and 2 can be placed in a microwave oven or equivalent equipment. Microwave ovens operate by exciting the water molecules of the products to be reheated thereby creating steam which it is often necessary to evacuate from a closed medium, such as the casing 8, so as not to damage either of the elements 1 and 2 present in the microwave element and especially to prevent the product from becoming saturated with water. For this purpose, the elongated tab 6 can be introduced by the user into the casing 8 to constitute a small communication passage between the interior of the casing 8 and the exterior atmospheric air which allows the steam to be evacuated from the casing 8 under the effect of its own pressure.

It is thereby possible to preserve perishable products by protecting them against contact with the atmospheric air. Preserving the product in a casing 8 or airtight volume without contact with the ambient air makes it possible to preserve its aroma, its texture and all of the product's original properties.

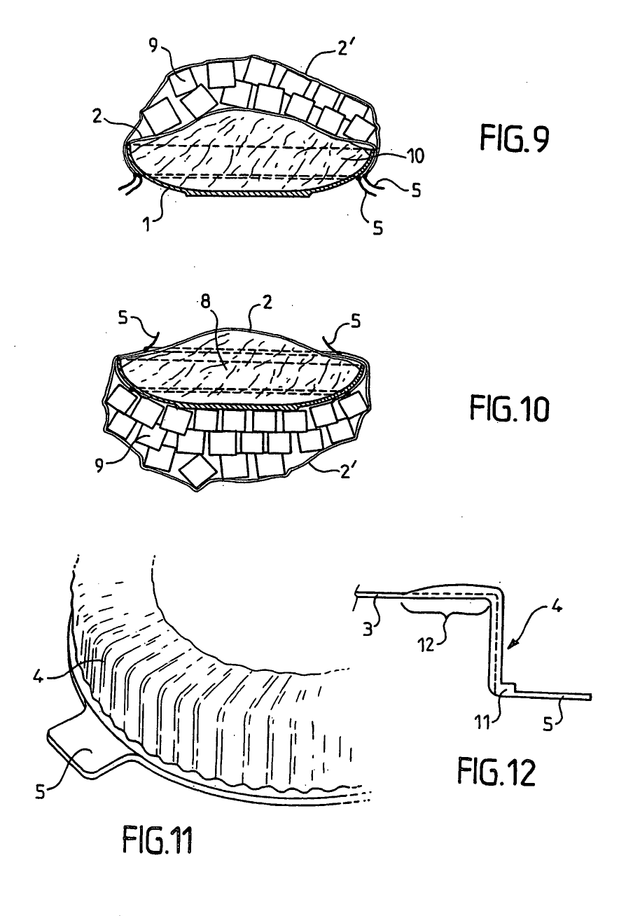

According to a possibility offered by the invention and represented in FIGS. 9 and 10, a second envelope 2′ can be attached to the first envelope 2 and/or to the container 1. This second envelope 2′ could advantageously contain a certain amount of ice 9 or of another heat-insulating product capable of maintaining the foodstuffs or product at a relative low temperature to prevent, especially, spoilage. A multiplicity of envelopes can be attached to increase or improve the temperature-reduction or temperature-maintenance effect of the product or foodstuffs.

According to another embodiment illustrated in FIGS. 11 and 12, the end 12 of the plane surface 3 is reinforced in thickness and extended in fluted form, e.g., describing a sinusoidal form along the cylindrical portion 4. The cylindrical portion 4 then ends with a reinforcement 11, e.g., of square shape. This reinforcement is particularly useful for preventing indentation phenomena.

According to this embodiment, the end 12 of the plane surface 2 and the cylindrical portion 4 have a thickness greater than the rest of the plane surface 2. It is therefore possible for the plane surface to have, e.g., a thickness of 0.44 millimeters±0.05 mm, with its end as well as the cylindrical portion having a thickness ranging from 0.44 mm±0.05 mm at the recess of the sinusoidal fluting to 1.44 mm±0.05 at the peak of the sinusoidal fluting. As a result of this texture, the device according to the invention can easily be washed and reused on similar or different foodstuffs or products.

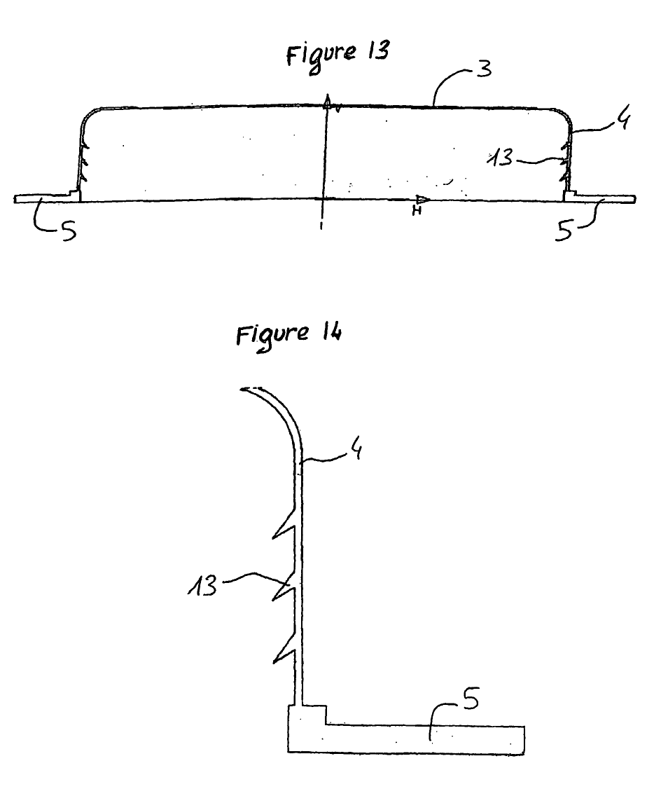

In another embodiment shown in FIGS. 13 and 14, the portion 4 of essentially cylindrical form extending from the plane surface 3 comprises a multiplicity of elastic oblique elements 13 capable of ensuring in a particularly effective manner the airtightness of the airtight casing 8. For this purpose, the aforesaid oblique elements 13 are located on the internal surface of the cylindrical portion 4, i.e., the oblique elements are in contact with the walls of the container 1.

These oblique elements 13 can be in the same manner constitutive of the portion 4 or be attached to the surface of this portion 4. In this case, the oblique elements 13 can be made of any material capable of ensuring the airtightness of the casing 8.

The invention is described above as an example. It is understood that one skilled in the art can implement or envisage different variants of the method and device for preserving perishable product according to the invention without thereby going beyond the scope of the patent, in particular with regard to the shape of the envelope 2 (round, oval, square, rectangular or any other shape) or its dimensions. Envelope 2 must simply be able to fit on the form of the container 1. Similarly, the number of tabs 5, 5′, 5″ or 6 and/or their arrangement on the envelope 2 merely constitute embodiments of the device according to the invention.

1. A method of preserving a perishable product placed in a container comprising:
attaching a flexible envelope comprising at least one protruding tab on at least a part of ends of the container to form an airtight casing for the products evacuating fluid contained in the casing by spreading at least one of the tabs to form a temporary passage between the interior and exterior of the casing,
compressing or pressing the flexible envelope against the products and/or the container such that the fluid trapped in the casing is removed via the temporary passage,
blocking the passage, and
inserting at least one of the tabs inside the casing to form a communication conduit between the interior and the exterior of said casing.

2. The method according to claim 1, further comprising stretching the flexible envelope such that it fits to the ends of the container.

3. The method according to claim 1, further comprising inserting at least one tab in the casing, heating and/or cooking the products enclosed in the casing by microwave or other heating equipment.

4. The method according to claim 1, further comprising writing on a surface of the envelope to identify the product present in the casing.

5. The method according to claim 1, further comprising attaching of a support illustrating a warning related to the product and/or a communication of a general nature, on a surface of the envelope.

6. The method according to claim 1, further comprising attaching at least a second envelope to a first envelope and/or to the container, the second envelope being capable of containing ice cubes or a heat-insulating product to reduce and/or maintain the temperature of the perishable product.

7. A preservation device comprising a multiplicity of protruding tabs, at least one of the protruding tabs having a greater length than the other tabs.

8. The preservation device according to claim 7, wherein the envelope has an essentially circular plane surface at an end of which extends perpendicularly a portion of essentially cylindrical form.

9. The preservation device according to claim 7, wherein the protruding tabs extend in a plane parallel to a plane defined by the surface of the envelope.

10. The preservation device according to claim 9, wherein the protruding tabs are located essentially at ends of the cylindrical portion.

11. The preservation device according to claim 7, wherein the protruding tabs are arranged in pairs opposite each other.

12. The preservation device according to claim 7, wherein the envelope is made of plastic.

13. The preservation device according to claim 12, wherein the envelope is made of an elastomer.

14. The preservation device according to claim 8, wherein an end of the surface and the cylindrical portion have a thickness greater than the rest of the surface.

15. The preservation device according to claim 14, wherein the greater thickness is in fluted form describing a sinusoidal form.

16. The preservation device according to claim 14, wherein the surface has a thickness of 0.44 millimeters±0.05 mm, with an end as well as the cylindrical portion having a thickness ranging from 0.44 mm±0.05 mm at a recess of the sinusoidal fluting to 1.44 mm±0.05 at a peak of the sinusoidal fluting.

17. The preservation device according to claim 8, the portion comprises a multiplicity of oblique elastic elements capable of ensuring a airtightness of the casing.

18. The preservation device according to claim 17, wherein the oblique elements are located on an internal surface of the cylindrical portion in contact with walls of the container.
